(19) United States
(12) Patent Application Publication
(10) Pub. No.: US 2020/0070207 A1
(43) Pub. Date: Mar. 5, 2020

(54) Component Box for Optimizing Screening and Taking Work

(71) Applicant: Xianrong Wang, Shanghai City (CN)

(72) Inventor: Xianrong Wang, Shanghai City (CN)

(21) Appl. No.: 16/675,228

(22) Filed: Nov. 6, 2019

(30) Foreign Application Priority Data
May 6, 2019 (CN) 2019103717574

(51) Int. Cl. B07B 13/04; B07B 13/16

(52) U.S. Cl. CPC B07B 13/04; B07B 13/16

(57) ABSTRACT

The invention discloses a component box for optimizing screening and taking work, comprising a base, wherein the upper end surface of the base is rotatably connected with supporting columns extending up and down, and the upper end of the supporting column is fixedly connected with the upper and lower sides respectively a temporary storage device, the gathering block is provided with an opening upward receiving groove, and the receiving groove can collect the falling parts In the receiving groove, the inner wall of the front side of the receiving groove is provided with a slideway; the present invention utilizes a downwardly extending spiral pipe with different thicknesses of the falling pipe, and sequentially screens the parts of different specifications, which may cause confusion due to the mobile carrying. The parts are distinguished again.

### CROSS-REFERENCES TO RELATED APPLICATIONS

The present application claims priority from Chinese application No. 2019103717574 filed on May 6, 2019 which is hereby incorporated by reference in its entirety.

### TECHNICAL FIELD

The invention relates to the field of luggage items, in particular to a component box for optimizing screening and taking work.

### BACKGROUND OF THE INVENTION

The traditional parts box is a box that separates multiple sets of independent chambers. After being shocked, the inside will be confused and will not be placed according to the original setting, which will bring waste of time to the subsequent selection work and increase the operator's Labor amount, an apparatus set forth in the present invention that solves the above problems.

### BRIEF SUMMARY OF THE INVENTION

The technical problem to be solved by the invention is to provide a component box for optimizing screening and taking work, so as to overcome the problems existing in the prior art.

A component box for optimizing screening and taking work includes a base 25, and an upper end surface of the base 25 is rotatably connected with a support column 29 extending upward and downward, and the upper end of the support post 29 is fixedly connected and respectively The temporary storage device 901 is taken up and down, and the support column 29 is rotatably connected with a gathering block 23 at the lower end of the temporary storage device 901. The gathering block 23 is provided with an opening groove 22 with an opening upward. The receiving groove 22 can collect and drop the falling parts. The front side inner wall of the receiving groove 22 is connected with a slideway 35. The slide path 35 is slidably connected to the lower side of the temporary storage device 901. a connecting device 902 for controlling, a fixing rod 30 is rotatably connected to the supporting column 29, and the fixing rod 30 is provided with a screening device 903 for distinguishing the size of the parts by using different diameters of the pipes, and the screening device 903 and the The receiving slot 22 is connected in series. The support post 29 is provided with an annular groove 28 at the lower end of the screening device 903. The ring groove 28 is slidably connected with a switching device 904, and the switching device 904 is controlled by up and down movement. Said company Device 902, the switching device 904 the screening device 903 served by the rotation control part.

Advantageously, the temporary storage device 901 includes a circumferential portion 42 disposed on the outer side of the storage box 11, and the housing 42 is provided with a storage cavity 17 communicating with the storage box 11 in a vertical direction. The storage box 11 is fixed on the storage box 11 Four partition plates 34 having a central symmetry are connected, and the partition plate 34 divides the storage cavity 17 into four equal division spaces, and the upper end faces of the partition plates 34 on the left and right sides are slidably connected with a slider 15 for the storage. The upper end surface of the box 11 is rotatably connected with a left and right symmetrical semicircular plate 12, and the semicircular plate 12 is provided with a downwardly downward groove 16 in which a fixed shaft 13 is rotatably coupled, and the fixed shaft 13 is mounted thereon. A pull rod 14 is disposed in an articulated connection with the slider 15, and a torsion spring 36 is connected between the front end surface of the pull rod 14 and the inner wall of the front end of the recess 16, and the lower end of the storage chamber 17 is rotatably connected with a centrally symmetric four. a blocking door 33 is provided with an opening slot 18 on a side close to the center of the symmetry, and the chain slot 19 is rotatably connected to the opening slot 18, and the upper side of the receiving cavity 17 is opened by the semicircular plate 12 The closing state changes, and the opening and closing state of the lower side of the housing cavity 17 is changed by the shutter 33.

Advantageously, the connecting device 902 includes a turntable 24 disposed on the support post 29 and slidably coupled to the slide rail 35. The support post 29 is rotatably coupled to a cone 20 at an upper end of the turntable 24. Four cones 21 of central symmetry are slidably coupled to the cone 20, and the lifting rods 21 are respectively hingedly connected to the chain rod 19, and the turntable 24 is slidably connected, and the lifting rod 21 controls the The link 19 is in communication with the underside of the receiving chamber 17, and is guided by the inclined surface of the cone 20 to cause the component to fall within the receiving groove 22.

Advantageously, the screening device 903 comprises four sorting tubes 31 fixedly connected to the fixed rod 30 and centrally symmetrical, wherein the height of the sorting tube 31 is sequentially lowered, and the sorting tube 31 is high to low. The counterclockwise inner wall of the lower end of the sorting tube 31 is provided with a rotary groove 40. The rotary groove 40 is rotatably connected with an elastically recoverable valve 41. The lower end of the valve 41 is provided with a shift lever 39. And the length of the lever 39 is sequentially increased, and the inner wall of the lower end of the receiving slot 22 is provided with a spiral tube 32 at the rear end of the turntable 24, and the fixing rod 30 and the spiral tube 32 are connected to each other. The sorting tube 31 allows the size of the parts to be slid to be different, and the parts slide in the spiral tube 32 for screening and fall within the sorting tube 31.

Advantageously, the switching device 904 includes four sorting boxes 27 that are slidably coupled to the annular groove 28 and are centrally symmetrical, the sorting boxes 27 being combined to form a complete annular box, the sorting box 27 A compression spring 26 is connected between the lower end and the inner wall of the lower end of the annular groove 28, and the classification box 27 is provided with a different cavity 37 having an opening upward, and the inner cavity of the difference cavity 37 is abutted against the lever 39. a plate 38, and the height of the push plate 38 is sequentially decreased, that is, the highest push plate 38 corresponds to the shortest shift lever 39, and the upper end surface of the push plate 38 is fixedly connected with the lower end of the lift rod 21, Pulling the sorting box 27 downward, controlling the downward movement of the lifting rod 21, thereby controlling the temporary storage device 901, and rotating the sorting box 27 counterclockwise, through the push plate 38 and the lever 39 The abutment connects the sorting tube 31 to slide the part out.

The invention has the beneficial effects that the present invention utilizes a downwardly extending spiral pipe with different thickness drop pipes, sequentially screens parts of different specifications, and separately distinguishes parts originally caused by moving and carrying confusion, thereby saving operator selection. Time to improve work efficiency.

### BRIEF DESCRIPTION OF THE DRAWINGS

FIG. 1 is a schematic view of the overall structure of the present invention;

FIG. 2 is a schematic view showing the structure of A-A in FIG. 1;

FIG. 3 is a right side view of the arcuate block 52 of FIG. 1;

FIG. 4 is a schematic view showing the structure of B-B in FIG. 1;

FIG. 5 is a schematic view showing the structure of C-C in FIG. 1;

FIG. 6 is a schematic view showing the structure of D in FIG. 1;

### DETAILED DESCRIPTION OF THE INVENTION

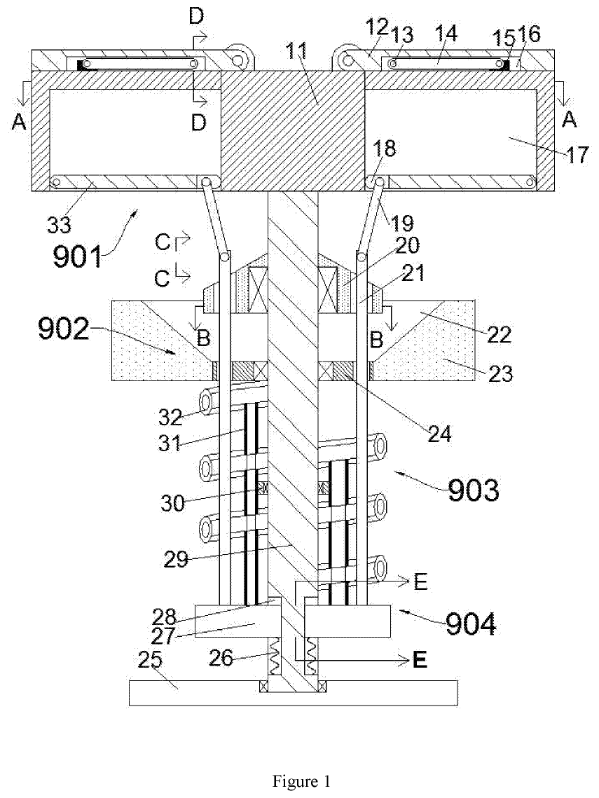

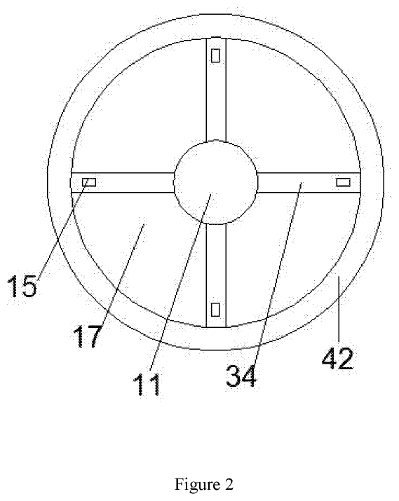

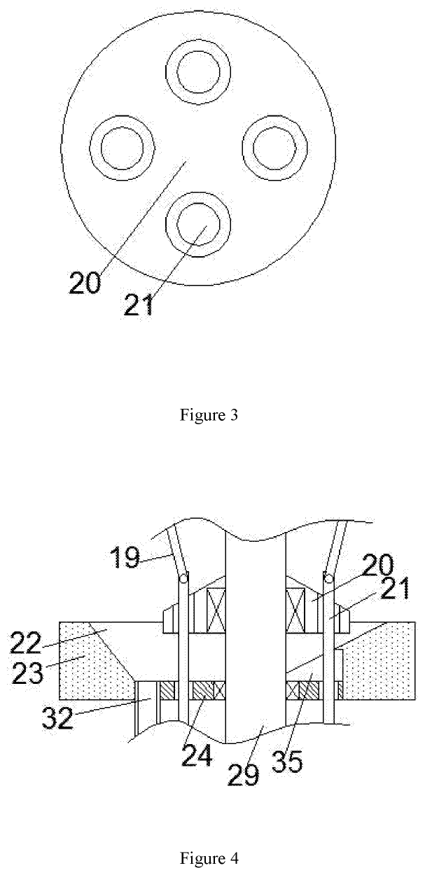

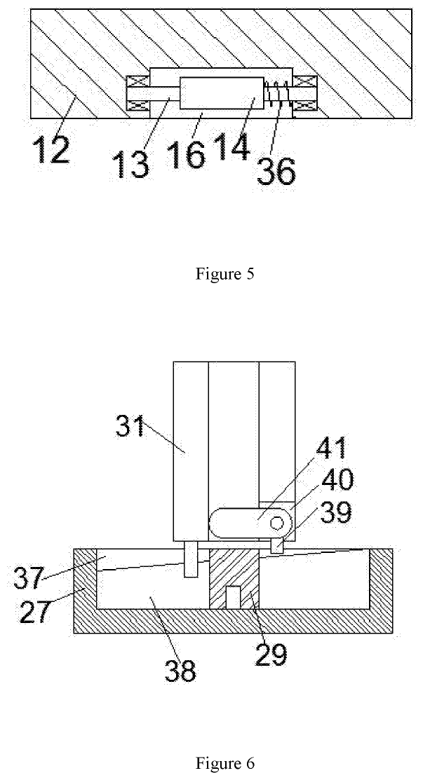

The invention will be described in detail below referring to FIG. 1 to FIG. 6. For better explanation, the orientations described hereinafter are defined as follows: directions of up, down, front and rear in the text are identical to the directions of up, down, front and rear of FIG. 1.

According to the present invention, a component box for optimizing screening and taking work includes a base 25, and an upper end surface of the base 25 is rotatably connected with a support column 29 extending upward and downward, and the upper end of the support post 29 is fixedly connected and respectively The temporary storage device 901 is taken up and down, and the support column 29 is rotatably connected with a gathering block 23 at the lower end of the temporary storage device 901. The gathering block 23 is provided with an opening groove 22 with an opening upward. The receiving groove 22 can collect and drop the falling parts. The front side inner wall of the receiving groove 22 is connected with a slideway 35. The slide path 35 is slidably connected to the lower side of the temporary storage device 901. a connecting device 902 for controlling, a fixing rod 30 is rotatably connected to the supporting column 29, and the fixing rod 30 is provided with a screening device 903 for distinguishing the size of the parts by using different diameters of the pipes, and the screening device 903 and the The receiving slot 22 is connected in series. The support post 29 is provided with an annular groove 28 at the lower end of the screening device 903. The ring groove 28 is slidably connected with a switching device 904, and the switching device 904 is controlled by up and down movement. Said company Device 902, the switching device 904 the screening device 903 served by the rotation control part.

Advantageously, the temporary storage device 901 includes a circumferential portion 42 disposed on the outer side of the storage box 11, and the housing 42 is provided with a storage cavity 17 communicating with the storage box 11 in a vertical direction. The storage box 11 is fixed on the storage box 11 Four partition plates 34 having a central symmetry are connected, and the partition plate 34 divides the storage cavity 17 into four equal division spaces, and the upper end faces of the partition plates 34 on the left and right sides are slidably connected with a slider 15 for the storage. The upper end surface of the box 11 is rotatably connected with a left and right symmetrical semicircular plate 12, and the semicircular plate 12 is provided with a downwardly downward groove 16 in which a fixed shaft 13 is rotatably coupled, and the fixed shaft 13 is mounted thereon. A pull rod 14 is disposed in an articulated connection with the slider 15, and a torsion spring 36 is connected between the front end surface of the pull rod 14 and the inner wall of the front end of the recess 16, and the lower end of the storage chamber 17 is rotatably connected with a centrally symmetric four. a blocking door 33 is provided with an opening slot 18 on a side close to the center of the symmetry, and the chain slot 19 is rotatably connected to the opening slot 18, and the upper side of the receiving cavity 17 is opened by the semicircular plate 12 The closing state changes, and the opening and closing state of the lower side of the housing cavity 17 is changed by the shutter 33.

Advantageously, the connecting device 902 includes a turntable 24 disposed on the support post 29 and slidably coupled to the slide rail 35. The support post 29 is rotatably coupled to a cone 20 at an upper end of the turntable 24. Four cones 21 of central symmetry are slidably coupled to the cone 20, and the lifting rods 21 are respectively hingedly connected to the chain rod 19, and the turntable 24 is slidably connected, and the lifting rod 21 controls the The link 19 is in communication with the underside of the receiving chamber 17, and is guided by the inclined surface of the cone 20 to cause the component to fall within the receiving groove 22.

Advantageously, the screening device 903 comprises four sorting tubes 31 fixedly connected to the fixed rod 30 and centrally symmetrical, wherein the height of the sorting tube 31 is sequentially lowered, and the sorting tube 31 is high to low. The counterclockwise inner wall of the lower end of the sorting tube 31 is provided with a rotary groove 40. The rotary groove 40 is rotatably connected with an elastically recoverable valve 41. The lower end of the valve 41 is provided with a shift lever 39. And the length of the lever 39 is sequentially increased, and the inner wall of the lower end of the receiving slot 22 is provided with a spiral tube 32 at the rear end of the turntable 24, and the fixing rod 30 and the spiral tube 32 are connected to each other. The sorting tube 31 allows the size of the parts to be slid to be different, and the parts slide in the spiral tube 32 for screening and fall within the sorting tube 31.

Advantageously, the switching device 904 includes four sorting boxes 27 that are slidably coupled to the annular groove 28 and are centrally symmetrical, the sorting boxes 27 being combined to form a complete annular box, the sorting box 27 A compression spring 26 is connected between the lower end and the inner wall of the lower end of the annular groove 28, and the classification box 27 is provided with a different cavity 37 having an opening upward, and the inner cavity of the difference cavity 37 is abutted against the lever 39. a plate 38, and the height of the push plate 38 is sequentially decreased, that is, the highest push plate 38 corresponds to the shortest shift lever 39, and the upper end surface of the push plate 38 is fixedly connected with the lower end of the lift rod 21, Pulling the sorting box 27 downward, controlling the downward movement of the lifting rod 21, thereby controlling the temporary storage device 901, and rotating the sorting box 27 counterclockwise, through the push plate 38 and the lever 39 The abutment connects the sorting tube 31 to slide the part out.

During filling, the semi-circular plate 12 is manually turned up, and the slider 15 is pulled by the pull rod 14 to slide on the partition plate 34. At this time, due to the rotation of the pull rod 14, the torsion spring 36 accumulates the dynamic potential energy, and the parts are respectively placed in different sizes. In the accommodating chamber 17, the semicircular plate 12 is loosened, and the upper opening of the accommodating chamber 17 is reclosed under the elastic recovery of the torsion spring 36.

When the device is carried under vibration, the part will be separated from the original area. At this time, the sorting box 27 is pulled down, and the sliding door 38, the lifting rod 21, and the chain rod 19 are pulled to pull the flap 33 downward to make the part from the receiving cavity 17 It falls and slides down the guide groove 22 through the guide of the cone 20, and then slides downward from the spiral tube 32. At this time, since the diameter of the sorting tube 31 is different, the parts that can pass through from high to low are short and thin. The long thin type, the short thick type, the long thick type, the parts are sequentially screened and slipped into the sorting tube 31, and the sorting box 27 is rotated counterclockwise, at which time the abutment of the push plate 38 and the shift rod 39 pushes the rotary groove 40 downward. Rotating, the parts can be slid out from the sorting tube 31 into the corresponding distinguishing chamber 37, take the corresponding specifications of the parts according to the requirements, and then loosen the sorting box 27, under the elastic recovery of the compression spring 26, the sorting box 27 is smooth The hour hand slides and moves up, and the pusher door 33 is pushed up by the push plate 38, the lift lever 21, and the link 19 to reclose the lower opening of the storage chamber 17.

The invention has the beneficial effects that the present invention utilizes a downwardly extending spiral pipe with different thickness drop pipes, sequentially screens parts of different specifications, and separately distinguishes parts originally caused by moving and carrying confusion, thereby saving operator selection. Time to improve work efficiency.

In the above manner, those skilled in the art can make various changes depending on the mode of operation within the scope of the present invention.

1. A component box for optimizing screening and taking work, comprising:
a base, the upper end surface of the base is rotatably connected with a supporting column extending upward and downward, and the upper end of the supporting column is fixedly connected with a temporary position which can be respectively taken from the upper and lower sides a storage device, the support column is rotatably connected with a gathering block at a lower end of the temporary storage device, the gathering block is provided with an opening upward receiving groove, and the receiving groove can collect falling parts, wherein the receiving groove a sliding passage is disposed on the inner wall of the front side of the receiving slot, and a connecting device for controlling the opening and closing state of the lower side of the temporary storage device is slidably connected to the sliding channel, and the fixing column is rotatably connected with the fixing rod. The fixing rod is provided with a screening device for distinguishing the size of the parts by using different diameters of the pipes, and the screening device is connected with the receiving groove, and the supporting column is provided with an annular groove at the lower end of the screening device, A switching device is slidably coupled to the annular groove, and the switching device controls the connecting device by moving up and down, and the switching device controls the screening device to rotate the component by rotating.

2. The component box for optimizing screening and taking work according to claim 1, wherein the temporary storage device comprises a circumferential outer side of the storage box, and the storage box is Between the upper and lower ends, the storage chamber is fixedly connected with four partition plates, and the partition plate divides the storage chamber into four equal spaces, and the upper end faces of the left and right sides slide. A slider is connected, and the upper end surface of the storage box is rotatably connected with a left and right symmetrical semicircular plate, and the semicircular plate is provided with a downwardly downward groove, and the fixed axis is rotatably connected in the groove. a pull rod hingedly connected to the slider is disposed, a torsion spring is connected between the front end surface of the pull rod and the inner wall of the front end of the groove, and the lower end of the storage chamber is rotatably connected with four centrally symmetric doors. An opening slot is defined on a side of the blocking door near the center of the symmetry, and the chain slot is rotatably connected to the opening slot.

3. The component box for optimizing screening and taking work according to claim 1, wherein the connecting device comprises a turntable disposed on the support column and slidably connected to the slide rail. The support column is rotatably connected with a cone at an upper end of the turntable, the cone is slidably connected with four centrally symmetrical lifting rods, and the lifting rods are respectively hingedly connected with the chain rod, and the turntable Slide the connection.

4. The component box for optimizing screening and taking work according to claim 1, wherein the screening device comprises four sorting tubes fixedly connected to the fixing rod and centrally symmetric, wherein the The height of the sorting tube is sequentially decreased, and the diameter of the sorting tube is from small to large, and the counterclockwise inner wall of the lower end of the sorting tube is provided with a rotating groove, and the rotating connection in the rotating groove is elastically recoverable. The valve is provided with a shifting lever at the lower end of the valve, and the length of the shifting lever is sequentially increased. The inner wall of the lower end of the receiving slot is provided with a spiral tube at the rear end of the rotating shaft, and the fixing rod and the spiral tube are Connected to each other.

5. The component box for optimizing screening and taking work according to claim 1, wherein switching means comprises four sorting boxes which are slidably coupled to said annular groove and are centrally symmetrical. The classification box is combined into a complete annular box body, and a compression spring is connected between the lower end of the classification box and the inner wall of the lower end of the annular groove, and the classification box is provided with a different cavity with an opening upward. The height of the push plate is sequentially decreased, that is, the highest push plate corresponds to the shortest of the push rods, and the side end face of the push plate is opposite to the push plate. The lower end of the lifting rod is fixedly connected.
